(19) United States
(12) Patent Application Publication
(10) Pub. No.: US 2006/0097572 A1
(43) Pub. Date: May 11, 2006

(54) Level programmable power supply for communication assembly and method

(75) Inventors: Guy Drouin, Quebec city (CA); Martin Beaumont, Sainte-Foy (CA); Claude Sylvain, Quebec City (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Edwards Systems Technology, Inc.

(21) Appl. No.: 10/972,343

(22) Filed: Oct. 26, 2004

(51) Int. Cl. H04B 3/54; H01H 51/34; G05B 11/01; G08B 1/08

(52) U.S. Cl. 307/1; 307/132 R; 340/310.11; 340/538

(57) ABSTRACT

A switching power supply subsystem can function as a low-power, high-efficiency communications device with performance characteristics suited to a range of applications. Properties such as maximum data rate, output swing, and drive capability are selectable to suit specific applications.

### FIELD OF THE INVENTION

The present invention relates generally to electronic communications technologies. More particularly, the present invention relates to power supply subsystems and methods for their use for communication functions.

### BACKGROUND OF THE INVENTION

It is known in communications systems apparatus for medical facilities and other applications to use multiple-wire, switch-based signaling apparatus to send messages from remote sites such as patient rooms to central sites such as nurses' stations. A typical style of hardware to support such requirements might use a central power source to provide power to indicators located nearby, with electromechanical switches at remote sites providing electrical circuit closure to light lamps or otherwise to cause the central-site indicators to activate. Equivalent functionality can be achieved with remotely located power sources and switches that apply power to lamps or other indicators at a central location. These and other implementations can meet operational requirements, but can have significant shortcomings.

An obvious shortcoming is complexity. While the individual circuits in such systems are simple—commonly referred to as “flashlight” circuits, meaning that they can be as simple as a power supply, a switch, and a light bulb, connected by point-to-point conductors—functional verification can be tedious. In addition, while initial construction of such point-to-point systems requires extensive wiring, upgrading such a system to add functions can in some instances be comparable to initial installation in cost. Although wire pathways may already be established in an installation, it may be necessary, for example, to add as many wires as were originally in place to perform a relatively basic upgrade, in addition to any intended upgrading of terminal devices to support the enhanced functionality.

A significant shortcoming in some existing system types involves reliability. A system with wiring that interconnects power devices, switches, and indicators at separate locations can develop a fault that can remain undetected until an operational failure occurs. For example, an inoperable power supply, a broken wire, or even a burned-out lamp may not be noticed until a patient's request for attention goes unheeded. Automatic or intrinsic fault detection is in many cases nonexistent.

Still further shortcomings in some systems involve excess capability. That is, some systems, able to handle high data rates and high capacities, may be excessively costly or complex when applied to basic tasks. Alternative approaches may preferably provide a desirable balance between signal capacity and cost, for example.

Accordingly, it is desirable to provide a communication method and apparatus that balances simplicity of use, cost-effective implementation, intrinsic reliability, and convenient functional verification.

### SUMMARY OF THE INVENTION

The above and other features and advantages are achieved in some embodiments by a novel apparatus as herein disclosed. Message transmission from multiple remote stations to a central station can use switching power supply devices as transmitters, with the characteristics of the output signals determined by a few basic components and with operation controlled using basic signal inputs. Such transmitters can send a plurality of messages with simple wiring. Power requirements can be kept low by causing the transmitting devices to substantially shut down except while sending messages.

In accordance with one embodiment of the present invention, a communication device is provided. The communication device includes a switching power supply for use as a transmitter, a first network of power supply level-setting components that determines the characteristics of a first output signal level from the switching power supply, and a second network of power supply level-setting components that determines the characteristics of a second output signal level from the switching power supply. The communication device further includes a first signal input to which application of a first input signal selects between the first and second output signal levels, and a signal return node for the communication device.

In accordance with another embodiment of the present invention, a communication device is provided. The communication device includes a linear power supply for use as a transmitter, a first network of power supply level-setting components that determines the characteristics of a first output signal level from the linear power supply, and a second network of power supply level-setting components that determines the characteristics of a second output signal level from the linear power supply. The communication device further includes a first signal input to which application of a first input signal selects between the first and second output signal levels, and a signal return node for the communication device.

In accordance with another embodiment of the present invention, a communication device is provided that includes means for generating a first direct-current output voltage with respect to a return node. The generating means employs a switching power supply having a power input port, a power output port, and a feedback port. The output voltage at the power output port of the switching power supply is a function of a voltage applied to the power input port and of a feedback signal directed to the feedback port of the switching power supply. The communication device further includes means for establishing a first feedback signal level by establishing an impedance network fed by the output of the switching power supply, which network scales the output of the switching power supply to return a signal to the switching power supply feedback input, the characteristics of which scaled signal direct a specific first output level from the switching power supply. The communication device further includes means for altering the first feedback signal level to form a second feedback signal level by switchably modifying the impedance network, whereby the feedback port has the second feedback signal level impressed thereon in place of the first feedback signal level. The communication device further includes means for reversing a state of a switch, whereby the impedance network is modified, and whereby a second direct-current output voltage for the communication device is directed in place of the first direct-current output voltage.

In accordance with another embodiment of the present invention, a communication method is provided, comprising the steps of outputting a first output voltage using a voltage regulator, dividing the first output voltage with a divider network to form a feedback signal intermediate in magnitude between the output voltage and a return node voltage, directing the feedback signal back into a feedback input of the voltage regulator to establish a first output baseline level, and dynamically altering the ratio in the divider network to change the first output voltage to a second output voltage.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a transmitter that uses a switching power supply integrated circuit as a basic functional element.

FIG. 2 is a schematic diagram of an enhancement of the transmitter of FIG. 1 to support a greater number of data elements.

FIG. 3 is a schematic diagram of a transmitter that uses a linear regulator in place of the switching power supply IC of FIGS. 1 and 2.

### DETAILED DESCRIPTION

The invention will now be described with reference to the drawing figures, in which like reference numerals refer to like parts throughout. A preferred embodiment in accordance with the present invention provides a transmitter that uses a switching power supply integrated circuit as a transmitter.

Switching power supply technology is well enough established that most or all of a set of core functions of such a device can be embodied in a single, low-cost, monolithic integrated circuit (IC) device. Core functions for some switching power supply ICs include at least: an oscillator to establish a switching rate, which may be externally adjustable or triggerable; a reference voltage generator to permit output scaling; a pass transistor capable of conducting at least some input power to an output; and a ramp generator and comparator circuit to determine for each oscillator cycle the time duration for which the pass transistor needs to remain in the “on” state to maintain the output level. Many such ICs can implement bucking or boosting functions—or both—and can support voltage multiplication, inversion, current sourcing, current sinking, and other functions through the addition of external components.

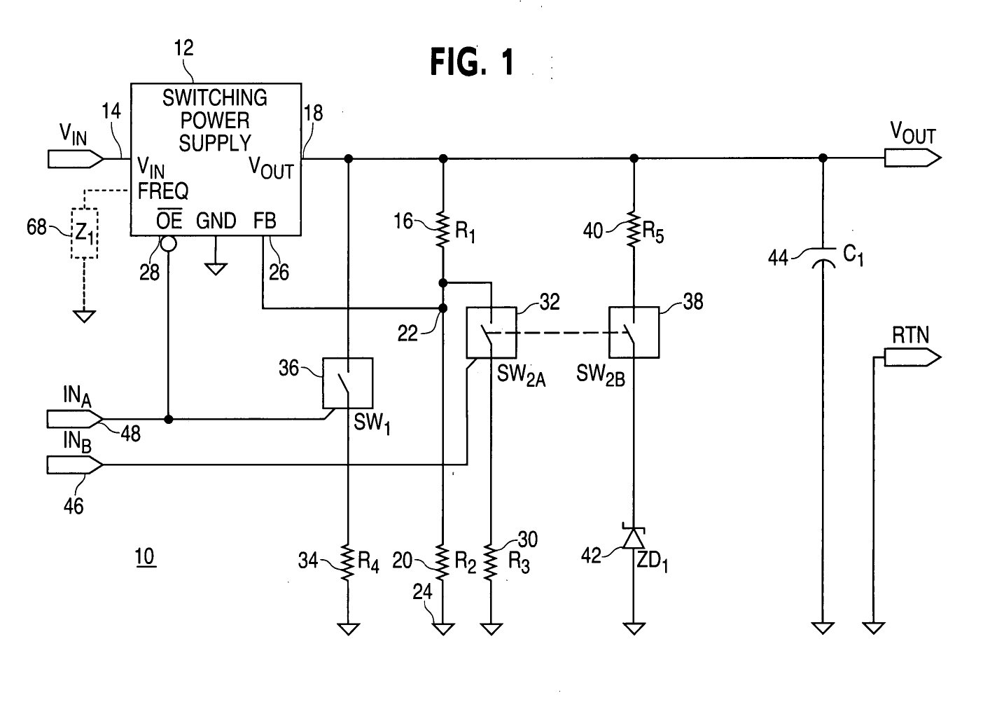

FIG. 1 is a schematic diagram of a transmitting device 10 according to the present invention. A switching power supply IC 12 is fed from a voltage source V_{IN} to an input terminal 14. The switching power supply IC 12 shown in FIG. 1 is programmable to a desired output voltage by a resistor divider, where R₁, the upper resistor 16, is connected directly to the switching power supply IC output terminal 18, and R₂, the lower resistor 20, is connected on one end to a common point 22 with the upper resistor 16 and on the other end to a return node 24. The common node 22 connecting R₁ and R₂ is also connected to a feedback terminal 26 of the switching power supply IC 12. It should be noted that some suitable models of switching power supply IC 12 may have a separate port for the output to the top of the divider R₁−R₂, and that a variety of wiring methods and resistance ratios for R₁ and R₂ may be required for various models of IC 12. Many models of IC 12, when configured for voltage output, require a connection by some element of an output level control function to a return node 24.

The return node 24 is shown by a specific style of ground symbol. All such “grounds” shown herein represent a common electrical potential within the limits of ordinary electrical wiring and circuit board track conductivity. It is to be understood that the “ground” shown does not necessarily correspond to earth ground, chassis ground, or any other connection external to the device being described, but is limited except as noted to provision of a zero-volt reference for the transmitter 10 being disclosed.

For simplicity in explanation, it will be assumed that the switching power supply IC 12 is, as a minimum, suitable for accepting, at an input port 14, a voltage that supplies direct current (DC) with positive polarity, and for outputting, at an output port 18, a lower positive DC voltage (closer to ground). It is to be understood that a range of devices suitable for the switching power supply IC 12 may also be capable of generating an output higher than the input, generating multiple outputs, or generating an output of opposite polarity from the input, while still other devices may accept negative DC input or alternating current (AC) input.

It is further to be understood that the device shown as a monolithic IC 12 in FIG. 1 may in some embodiments be a functional block made up of multiple devices. Some of the inputs and outputs of such a functional block may be those shown as inputs and outputs of a single IC 12 in FIG. 1. It is further to be understood that a typical switching power supply IC 12 includes, as part of its structure or as an accessory, an oscillator, or a port through which an oscillatory signal can be received. A fixed-rate or variable-rate oscillatory signal is required for control of the cyclical switching function of a switching power supply device. Control of the rate of oscillation may be achieved through various mechanisms, including accepting an external signal that sets a rate and connecting at least one external component that interacts with the internal structure of the power supply device to set a rate. The latter is represented herein by Z₁ 68.

The capacitor, resistors, diodes, and switches shown in the figures may preferably be types conforming to the following characteristics.

The capacitor may be a ceramic, electrolytic, or other common type with suitable capacitance, tolerance, temperature, equivalent series resistance (ESR), and voltage ratings. While a single capacitor is shown, the performance required may be achieved by interconnection of multiple devices. A large electrolytic capacitor with high ESR, for example, may preferably be bypassed with a small, low-ESR device if needed.

The resistors may in some embodiments be of composition, film, wire wound, or other types available in the resistances, tolerances, and reliability and power ratings required for the application.

The diodes are preferably reverse breakdown types, also referred to in the literature as avalanche, regulator, reference, and zener diodes, depending in part on the details of the mechanism by which their properties are achieved. The diodes described herein preferably have knee voltages and power ratings appropriate to the application. Single diodes are shown, but strings of diodes may be preferred to achieve specific voltage levels without recourse to a multiplicity of types, and monolithic arrays of diodes may be preferred to discrete units.

The switches are preferably electronic devices such as field effect transistors (FETs) that can be switched from being highly conductive to being largely nonconductive using logic-level control input signals. On-state resistance values of available FET switches range from a few hundred ohms to a fraction of an ohm, while off-state resistances are commonly many megohms. Typical FET switches are bidirectional (i.e., have largely symmetrical current carrying properties when either terminal of the switched path is more positive) and may be packaged in multiples in monolithic ICs that can include control and protection circuitry.

Electromechanical switches, such as sensitive switches, proximity switches, relays, and the like may represent acceptable alternative embodiments for at least one of the electronic switches described herein.

A control input to the preferred switching power supply IC 12, termed Output Enable 28, is active low. That is, applying an electrical signal that is more positive than the ground reference by an amount corresponding to a logic “1” in TTL or CMOS logic, for example, causes the IC to halt operation, while applying an electrical signal near the ground reference, corresponding to a logic “0” in TTL or CMOS logic, for example, allows the IC to operate.

R₃, a third resistor 30, is configured in parallel with R₂, connected to ground on the low side and connected on the opposite side to the R₁−R₂ junction 22 via SW_{2A}, an electrically-operated switch 32. R₄, a fourth resistor 34, is connected to ground on its low side and connected via SW₁, another electrically-operated switch 36, to the power supply IC output terminal 18. The power supply IC output terminal 18 has an additional load to ground consisting of SW_{2B}, another electrically-operated switch 38, in series with R₅, a fifth resistor 40, and ZD₁, a reverse breakdown diode 42. C₁, a capacitor 44, functions as an output filter and charge storage device.

With all three electrically-operated switches 32, 36, and 38 set in their substantially nonconductive state and the Output Enable 28 signal set active low, the switching power supply IC 12 accepts input power on its input terminal 14 and generates an output voltage on terminal 18 that is divided by the resistors R₁ and R₂ to generate a feedback signal 26 that regulates the output voltage of the switching power supply IC 12.

The foregoing describes a nominal configuration for a switching power supply that uses a monolithic IC and minimal external components, plus the switching control apparatus disclosed herein. Other circuit configurations are possible, and may add, for example, input and output inductors to the input and output terminals 14 and 18, respectively, as well as various combinations of output pass transistors to carry most of a high-power switching power supply IC's output current external to the IC. When the switching power supply IC 12 is used as part of a relatively low power communications device, most of these additional components may preferably be omitted, as shown in FIG. 1. The capacitor 44 is likely to provide sufficient filtering to meet the requirements for transmitting data in a representative system application.

As indicated above, for the schematic of FIG. 1, setting the three switches 32, 36, and 38 to logic zero produces the highest output voltage 18, herein termed V₀. Setting SW_{2A} 32 to a conductive state, in the circuit shown, requires setting IN_{B} 46 high, which also sets SW_{2B} 38 into conduction (assuming all of the switches conduct with a logic-1 input). A first effect of this operation is to place R₃ in parallel with R₂, lowering the divider voltage, as a result of which the output 18 of the switching power supply 10 in the circuit shown begins to slew toward operation at a lower voltage.

Switching power supply IC 12 devices use a resistive-divider configuration for establishing feedback voltage. Here, a feedback voltage would be scaled to R₂/(R₁+R₂), for example with a built-in voltage reference in the IC 12 used to control circuit operation. Adding R₃ (and omitting the resistance in SW_{2A} switch 32, which omission is appropriate for many contemporary electronic switch types) changes the feedback scaling to (R₂∥R₃)/(R₁+R₂∥R₃). If resistor R₃ (in series with the first switch 32) is appropriately selected, then the final output signal voltage can be approximately V₀/2, if desired. Since the expressions given include two equations in four unknowns, it is possible to select both V₀ and one of the resistors, then to solve the equations for the remaining unknowns. This will generally allow the output voltage range and the resistance range to be chosen, with the remaining resistors computed to satisfy the equations. A different IC 12 type with a different feedback circuit would require an analogous design process as determined by manufacturer specifications for that type.

A second effect of changing the state of IN_{B} 46 in the circuit of FIG. 1 is to connect the network of R₅ 40 and reverse breakdown diode ZD₁ 42 to the output node 18. If the breakdown voltage of diode ZD₁ is approximately equal to the lower output signal level V₀/2, then the diode ZD₁ conducts and draws charge out of the output filter capacitor 44 and the capacitive charge storage in a transmission line associated with the transmitting device 10 as long as a voltage differential in excess of the breakdown voltage of ZD₁ persists. This can increase the falling-edge slew speed of the circuit, and can be particularly effective in a highly isolated circuit, a circuit with long transmission lines, or where other current sinks to ground may be weak, which could result in an undesirably slow response time. The output level setting divider R₁−R₂(−R₃) may preferably use resistors with relatively large numerical values to reduce quiescent power consumption. Such resistor values could result in a slow slew rate if, for example, the resistors, and not the switched diode circuit, were relied upon to drive the output to the new voltage level.

Raising input signal IN_{A} 48 in FIG. 1 to a logic 1 changes the state of the second switch 36 and reverses the state of the Output Enable 28 input. This state change will, for a typical switching power supply IC 12, disable IC operation, so that no further power is delivered to the output node 18. As indicated above for switching from V₀ output to V₀/2 output, a high-impedance circuit may have very slow translation from the V₀ state to a lower state. The same logic applies when translating from V₀ or V₀/2 to a zero-output state, for which reason the SW₁ switch 36 and its associated resistor R₄ 34 to ground are provided. When SW₁ 36 is active, the charge in the capacitor 44 and in the transmission line and other load capacitances can be drained to ground 24 at a rate proportional to the effective total circuit capacitance and the net resistive load, including the resistor R₄ 34 and the level setting divider R₁−R₂(−R₃) as noted above. This effective RC network exhibits typical exponential decay in most applications, with any active circuitry in the output path 18, either internal to the IC 12 or associated with a detector circuit in a receiver, potentially accelerating some portion of the decay curve.

Pulling IN_{A} 48 low substantially reverses the above process, with current from the IC 12 driving the output to either V₀ or V₀/2, as determined by the state of IN_{B} 46 when IN_{A} 48 is changed. Similarly, reversing IN_{B} 46 when IN_{A} 48 is active low causes charge from the IC 12 to drive the output from V₀/2 to V₀ at a rate controlled by circuit properties such as the output drive characteristics of the IC 12 and the capacitance of the capacitor 44, the transmission line, and any receiver load. The rising edge timing characteristics of the output signal 18 are determined by factors including the source impedance of the power source feeding the switching power supply IC 12 and the drive circuitry in the IC 12. For example, if the IC 12 includes a substantially conventional operational amplifier in the output section thereof, the effective dynamic output impedance of the IC 12 may be as low as or less than a few ohms.

The invention is capable of transmitting data at a rate related to several characteristics of the specific embodiment. For example, slewing from V₀ to V₀/2 occurs with the switching power supply IC 12 momentarily cut off, so that the slew rate is a function of the total energy storage in the transmission line to the receiver, including lumped and distributed capacitances and inductances, and the resistance of the resistor R₅. Slewing from V₀/2 to V₀, by contrast, occurs at a rate controlled by the ability of the IC 12 to pump charge into the transmission line. Since the IC 12 employs a switching circuit, charge is pumped into the transmission line during only a part of each cycle of the IC 12 for typical switching power supply ICs. The output capacitor 44 may reduce switch rate ripple in the output, in exchange for reducing the maximum slew rate. Thus the data rate limit in a transmitter using the invention depends on output circuit impedance from all sources, drive capability of the switching power supply IC 12, and the switching rate of the IC 12.

Detection of the transmitted signal requires that the detector be able to discriminate between the states, so the receiving circuit may preferably include a threshold detection circuit at least as fast as the maximum applied data rate. In sampled applications, Nyquist criteria may apply, so that the receiver should sample the signal line at least twice as fast as the data rate used in the application.

System data rate will thus be determined in part by factors such as transmission line characteristic impedance, unit capacitance and inductance, length, and termination style, as well as driver IC 12 properties such as clock frequency. Like other communication systems, the inventive apparatus requires an application specification to guide users regarding maximum data rate as a function of circuit and transmission line characteristics.

If R₃ 30 and SW_{2A} 32 are configured across R₁ 16 instead of R₂ 20, then the feedback level when SW_{2A} 32 is on will typically be more positive than when SW_{2A} 32 is off. In that configuration, it may be preferable for SW_{2B} 38 to be fed via a logic inverter, or to be of a type that is conductive when its input is low. Then the output states for IN_{B} 46 will be reversed from those indicated above, and V₀ will preferably be computed based on the ratio R₂/(R₂+R₁∥R₃), with V₀/2 based on R₂/(R₁+R₂).

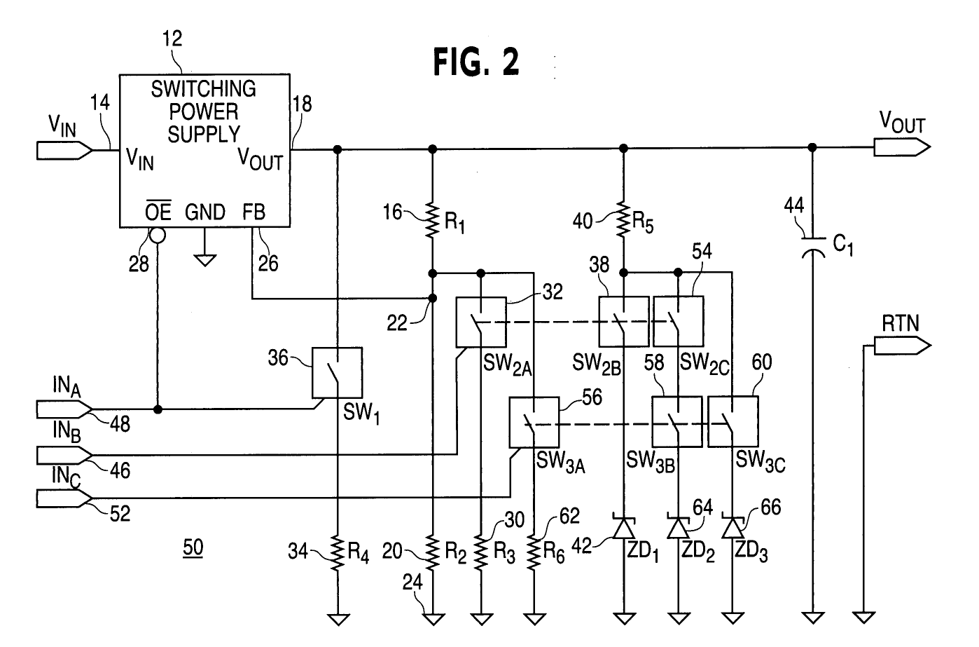

FIG. 2 is a schematic showing that, in another embodiment 50, the invention can be generalized to transmit more logic states. As in FIG. 1, IN_{A} 48 may be viewed as an enable signal, which must be active (low, in the configurations shown in FIGS. 1 and 2) in order for IN_{B} 46 to transmit either of its states. For a third input IN_{C} 52, which can be high or low independent of IN_{A} 48 and IN_{B} 46, additional switches SW_{2C} 54, SW_{3A} 56, SW_{3B} 58, and SW_{3C} 60 and associated components R₆ 62, ZD₂ 64, and ZD₃ 66 can change the switching power supply output 18 to any of four nonzero states to represent all possible combinations of IN_{B} 46 and IN_{C} 52, for example. As shown, with all switches open, the output sits at its highest value, V₀. As combinations of switches close, successively lower outputs are set.

The resistor values determine the output levels, which may preferably be selected so that a receiver can distinguish between them accurately with a variety of interconnecting cable lengths. Thus, when IN_{B} 46 is active and IN_{C} 52 is inactive, R₂ 20 and R₃ 30 in parallel set the feedback node 26's level, and thus the output level 18 of the transmitter 50. When IN_{C} 52 is active and IN_{B} 46 is inactive, R₂ 20 and R₆ 62 are in parallel instead. When both IN_{C} 52 and IN_{B} 46 are active, all three resistors R₂ 20, R₃ 30, and R₆ 62 are in parallel. Properly chosen resistor values can assure that all of the resistor combinations define distinct and detectable levels.

In switching from V₀ to the state in which IN_{C} 52 alone is active, the three elements of SW₃, 56, 58, and 60, are activated. As noted, this causes the switching power supply 50 to shift to another, lower, level. At the same time, a circuit similar to that of SW_{2B} 38 and ZD₁ 42 is activated to increase switching speed. In this mode, SW_{3C} 60 conducts, connecting the output 18 to ZD₃ 66 through R₅ 40. ZD₃ 66 is preferably a reverse breakdown diode with a voltage nominally equal to the intended output 18, so that it will draw current approximately until the output signal 18 reaches its final value. It is to be noted that the use of a single resistor R₅ 40 to draw all falling-edge current is optional, and other configurations, such as one in which each of the diode-and-switch combinations would have a separate resistor, are equally valid electrically and may be preferred for some embodiments.

In order to switch from any higher output 18 voltage to the lowest voltage, both IN_{B} 46 and IN_{C} 52 must be active. This activates both switches SW_{2C} 54 and SW_{3B} 58, so that diode ZD₂ 64 can draw current. Note that both ZD₁ 42 and ZD₃ 66 can be active until the output signal 18 drops below their respective breakdown voltages. Once the final voltage is reached, all three diodes are inactive.

The 4-state arrangement described can be extended to any number of distinct levels, although binary multiples may be preferred. A receiver for a multiple-level transmitter 50 embodiment may have, for example, multiple analog comparators or an analog-to-digital converter to detect the various levels and determine the corresponding combinations of logic states. If each of a multiplicity of transmitters is directly wired to a separate input channel in a receiver, which connectivity may be facilitated using an analog multiplexer, for example, then the received signal for each channel can be scaled to account for differing wire lengths, tolerances in individual resistor values, and other variations between transmitters before or after being decoded from a voltage level to a logic combination.

The invention is shown using a switching power supply, a term that describes a general class of devices that preferably use a DC input to create a DC output, where the input may be poorly regulated and the output regulation is typically quite good, although the presence of some output ripple at the switching rate is common. The presence of significant artifacts (i.e., switch rate ripple and its harmonics as well as noise passthrough from the DC input power, which may include ripple at the frequency of the facility power AC, for example) in the transmitted signal may have little effect on circuit function provided the receiver includes filtering, averaging, or hysteresis appropriate to the amplitude of the artifacts.

Use of a switching power supply is generally desirable, since contemporary switching power supply ICs can achieve high efficiency, which translates to minimal dissipated power within the power supply itself. However, it is also possible in the present invention to use an adjustable linear regulator in place of the switching power supply IC, where decreased efficiency may be offset by other considerations. In particular, high efficiency in switching power supply applications is most noticeably achieved near the maximum output of which a given supply is capable. Thus, since the present invention preferably consumes low total power, design for high efficiency at low total output is appropriate, but a relatively inefficient linear regulator may be acceptable.

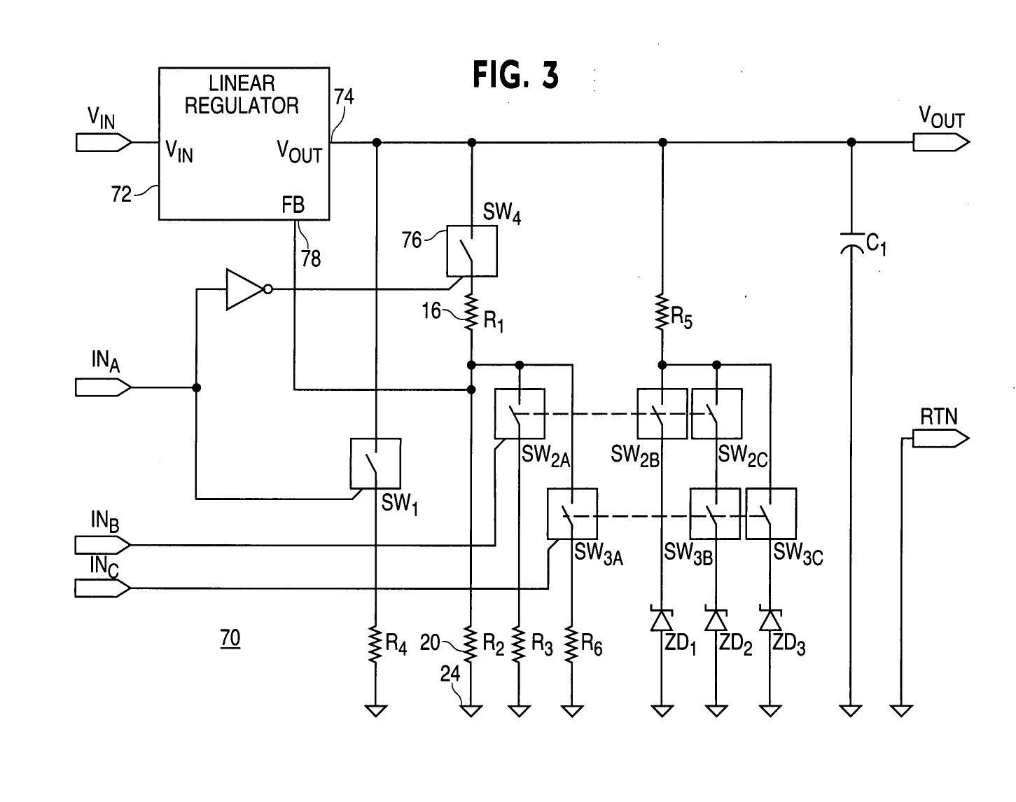

In using a linear regulator for a transmitter 70, as shown in FIG. 3, if an ordinary device such as a monolithic three terminal regulator 72 is used as the source for the output signal 74, the regulator 72 may lack an output enable terminal. In that case, it may be preferred to use an additional electronic switch SW₄ 76 to interrupt the R₁ 16 path, effectively drawing the feedback point 78 to ground 24 through R₂ 20.

It may also be preferred in some embodiments to use an AC circuit instead of DC, which may be facilitated by using back-to-back or double-ended diodes in place of the single diodes shown for ZD₁, ZD₂, and ZD₃ to allow the output to swing both positive and negative with respect to the ground reference. Use of AC can allow transformer isolation and other options to be included. An AC signal receiver preferably uses rectification and filtering, Nyquist-rate sampling, or another satisfactory AC measurement technique to sense signal magnitude.

In a specific case described in a U.S. patent application entitled, “VOLTAGE ISOLATED DETECTION APPARATUS AND METHOD,” filed Aug. 27, 2004, having U.S. patent application Ser. No. 10/926,994, a call cord for use with a wall-mounted medical facility communication device can be unplugged or plugged in, and has a single button on it that can be pressed by a patient. If the unplugged/plugged status and the button belong to electrical circuits generating signals, then the unplugged/plugged signal and the pressed signal described in the above-referenced patent application can be connected, in one mode of use, to IN_{A} 48 and IN_{B} 46, respectively, in FIG. 1, so that plugging in the call cord represents an enable that raises the output from zero to maximum, and pressing the switch lowers the output to half voltage. This allows a central station to have positive confirmation for every call cord that is plugged in, as well as to receive a distinct signal when a button is pressed. The state of IN_{B} 46 for each condition of the button press signal can be reversed, so that the output is V₀/2 when the button is not pressed, and V₀ when it is.

For both the FIG. 1 and the FIG. 2 configurations, some system failures may be directly detectable by a receiver. In an embodiment using the FIG. 1 configuration for a call cord transmitter, for example, each remote station for which the call cord is unplugged should sit at roughly zero volts, with the capacitor 44 providing some quieting of coupled electrical noise. Each station for which a call cord is plugged in should output V₀, which can be indicated by, for example, a green indicator on a display panel at a central station. Pressing a call cord button lowers the transmitted output at that remote station to V₀/2, which can cause a red indicator, for example, to replace the green in a suitably designed receiver. A constant red indicator may then suggest a stuck switch or other fault, while a green indicator where no call cord is plugged in suggests another fault, and a lack of any indication where a call cord is known to be plugged in suggests yet another fault. Since the same wires are used to transmit at least two distinguishable messages, display of a “normal” message can indicate at least that the power supply at every station is operational and that the wires to the receiver are intact.

Upgrading from a FIG. 1 system to a FIG. 2 system can more than double the number of distinct messages that can be sent without necessitating wiring changes. While the transmitters and the receiver may need to be upgraded, wiring expense can be avoided, which can represent a significant saving. Either of the systems may be installed as an upgrade replacing a prior design, with the potential of reusing existing wiring.

Although the switching power supply IC-based transmitter shown is useful in support of medical facility messaging, it can also be used in other environments such as manufacturing, warehousing, and office environments where low power or low cost may be a principal consideration.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

What is claimed is:

1. A communication device, comprising:
a switching power supply for use as a transmitter;
a first network of power supply level-setting components that determines the characteristics of a first output signal level from the switching power supply;
a second network of power supply level-setting components that determines the characteristics of a second output signal level from the switching power supply;
a first signal input to which application of a first input signal selects between the first and second output signal levels; and
a signal return node for the communication device.

2. The communication device of claim 1, further comprising:
a third network of power supply level-setting components that determines the characteristics of at least one additional output signal level from the switching power supply; and
a second signal input that interoperates with the first signal input so that application of the first input signal a second input signal selects between output signal levels by controlling the first, second, and third networks of power supply level-setting components.

3. The communication device of claim 2, wherein the switching power supply further comprises a switching power supply device having a power input port, a power output port, and a feedback port.

4. The communication device of claim 3, wherein the switching power supply further comprises a shunt capacitor from the power output port to the signal return node.

5. The communication device of claim 3, wherein the switching power supply device further comprises:
at least one oscillator frequency control port; and
an oscillator frequency control device connected to the at least one oscillator frequency control port.

6. The communication device of claim 3, wherein the switching power supply device further comprises a power supply enable input port, wherein application of the first input signal in an enable logic state causes operation of the power supply to be enabled, and wherein application of the first input signal in a disable logic state causes operation of the power supply device to be disabled.

7. The communication device of claim 6, wherein the first network of power supply level-setting components further comprises:
a first divider resistor, wherein a first terminal of the first divider resistor is linked to the power output port of the switching power supply device, and a second terminal of the first divider resistor is linked to the feedback port of the switching power supply device; and
a second divider resistor, wherein a first terminal of the second divider resistor is linked to the second end of the first divider resistor, and a second terminal of the second divider resistor is linked to the signal return node.

8. The communication device of claim 7, wherein the second network of power supply level-setting components further comprises:
a first switch, configurable to operate in a nonconductive mode and a conductive mode; and
a third resistor that, along with the first switch, forms a series string from the power output port of the switching power supply device to the signal return node.

9. The communication device of claim 8, wherein the first signal input further comprises a control input to switch the first switch between the nonconductive mode and the conductive mode thereof.

10. The communication device of claim 9, wherein the switching power supply is so configured that:
application of the first input signal in the enable logic state further configures the first switch in the nonconductive mode thereof; and
application of the first input signal in the disable logic state a further configures the first switch in the conductive mode thereof.

11. The communication device of claim 8, wherein the third network of power supply level-setting components further comprises:
a second switch, configurable to operate in a nonconductive mode and a conductive mode; and
a fourth resistor that, along with the second switch, forms a series string in parallel with the second divider resistor.

12. The communication device of claim 11, wherein the third network of power supply level-setting components further comprises:
a third switch, configurable to operate in a nonconductive mode and a conductive mode;
a fifth resistor; and
a first reverse-breakdown diode that, along with the third switch and the fifth resistor, forms a series string from the power output port to the signal return node.

13. The communication device of claim 12, wherein the switching power supply is so configured that:
application of the second input signal in a first state thereof further configures the second switch and the third switch in the respective nonconductive modes thereof, whereby the power supply is configured to operate at the first output signal level; and
application of the second input signal in a second state thereof further configures the second switch and the third switch in the respective conductive modes thereof, whereby the power supply is configured to operate at a third output signal level.

14. The communication device of claim 13, wherein the first reverse-breakdown diode has a breakdown voltage approximately equal to a voltage defined by the power supply when in operation in conjunction with the first, second, and fourth resistors and in conjunction with the second switch in the conductive mode, and wherein the fifth resistor limits current flow through the first reverse-breakdown diode.

15. The communication device of claim 11, further comprising:
a fourth network of power supply level-setting components that determines the characteristics of at least one additional output signal level from the switching power supply; and
a third signal input that interoperates with the first and second signal inputs so that application of the first, second, and third input signals selects between output signal levels by controlling the first, second, third, and fourth networks of power supply level-setting components.

16. The communication device of claim 15, wherein the fourth network of power supply level-setting components further comprises:
a fourth switch, configurable to operate in a conductive mode and a nonconductive mode; and
a sixth resistor that, along with the fourth switch, forms a series string paralleling one of the first and second divider resistors.

17. The communication device of claim 16, wherein the fourth network of power supply level-setting components further comprises:
a fifth switch, configurable to operate in a conductive mode and a nonconductive mode;
a sixth switch, configurable to operate in a conductive mode and a nonconductive mode, wherein the fifth switch and the sixth switch are connected in series; and
a second reverse-breakdown diode, wherein the second reverse-breakdown diode has a breakdown voltage approximately equal to the voltage defined by the power supply when in operation in conjunction with the first, second, third, and sixth resistors and in conjunction with the second and fourth switches in their respective conductive modes, and wherein, when both the fifth switch and the sixth switch are operated in their respective conductive modes, a current path is established from the power output port through a series string comprising the second reverse-breakdown diode and a resistor to the signal return node.

18. The communication device of claim 17, wherein at least one switch function is performed by an electromechanical switch.

19. The communication device of claim 16, wherein the fourth network of power supply level-setting components further comprises:
a seventh switch, configurable to operate in a conductive mode and a nonconductive mode; and
a third reverse-breakdown diode, wherein the third reverse-breakdown diode has a breakdown voltage approximately equal to the voltage defined by the power supply when in operation in conjunction with the first, second, and sixth resistors and in conjunction with the fourth switch in its conductive mode, and wherein, when the seventh switch is operated in its conductive mode, a current path is established from the power output port through a series string comprising the third diode and a resistor to the signal return node.

20. The communication device of claim 19, wherein at least one switch function is performed by an electromechanical switch.

21. The communication device of claim 8, wherein the third network of power supply level-setting components further comprises:
a second switch, configurable to operate in a nonconductive mode and a conductive mode; and
a fourth resistor that, along with the second switch, forms a series string paralleling the first divider resistor.

22. The communication device of claim 21, wherein the switching power supply is so configured that:
application of the second input signal in a first state thereof further configures the second switch in the nonconductive mode thereof and the third switch in the conductive mode thereof, whereby the power supply is configured to operate at a first output level; and
application of the second input signal in a second state thereof further configures the second switch in the conductive mode thereof and the third switch in the nonconductive mode thereof, whereby the power supply is configured to operate at a second output level.

23. The communication device of claim 2, further comprising:
a multiplicity of additional networks of power supply level-setting components that determine the characteristics of a multiplicity of additional output signal levels from the switching power supply device; and
a multiplicity of signal inputs that interoperate to select between output signal levels by controlling the multiplicity of networks of power supply level-setting components.

24. A communication device, comprising:
a linear power supply for use as a transmitter;
a first network of power supply level-setting components that determines the characteristics of a first output signal level from the linear power supply;
a second network of power supply level-setting components that determines the characteristics of a second output signal level from the linear power supply;
a first signal input to which application of a first input signal selects between the first and second output signal levels; and
a signal return node for the communication device.

25. The communication device of claim 24, further comprising:
a third network of power supply level-setting components that determines the characteristics of at least one additional output signal level from the linear power supply; and
a second signal input that interoperates with the first signal input so that application of the first input signal a second input signal selects between output signal levels by controlling the first, second, and third networks of power supply level-setting components.

26. A communication device, comprising:
means for generating a first direct-current output voltage with respect to a return node, wherein the generating means employs a switching power supply having a power input port, a power output port, and a feedback port, and wherein the output voltage at the power output port of the switching power supply is a function of a voltage applied to the power input port and of a feedback signal directed to the feedback port of the switching power supply;
means for establishing a first feedback signal level by establishing an impedance network fed by the output of the switching power supply, which network scales the output of the switching power supply to return a signal to the switching power supply feedback input, the characteristics of which scaled signal direct a specific first output level from the switching power supply;
means for altering the first feedback signal level to form a second feedback signal level by switchably modifying the impedance network, whereby the feedback port has the second feedback signal level impressed thereon in place of the first feedback signal level; and
means for reversing a state of a switch, whereby the impedance network is modified, and whereby a second direct-current output voltage for the communication device is directed in place of the first direct-current output voltage.

27. The communication device of claim 26, further comprising:
means for disabling operation of the voltage generating means; and
means for drawing the output voltage of the voltage generating means down to the voltage of the return node.

28. The communication device of claim 26, further comprising:
means for enabling operation of the voltage generating means; and
means for releasing the output voltage of the voltage generating means from being drawn down to the voltage of the return node.

29. The communication device of claim 26, further comprising:
means for increasing the rate at which the output voltage of the voltage generating means is drawn to a lower voltage level following setting of the switch state reversing means to a state in which a lower output voltage is directed.

30. A communication method, comprising the steps of:
outputting a first output voltage using a voltage regulator;
dividing the first output voltage with a divider network to form a feedback signal intermediate in magnitude between the output voltage and a return node voltage;
directing the feedback signal back into a feedback input of the voltage regulator to establish a first output baseline level; and
dynamically altering the ratio in the divider network to change the first output voltage to a second output voltage.

31. The communication method of claim 30, further comprising the steps of:
dynamically disabling the voltage regulator output; and
dynamically drawing the voltage regulator output down to the return node level.

32. The communication method of claim 30, further comprising the steps of:
dynamically enabling the voltage regulator output; and
dynamically releasing the voltage regulator output from being drawn down to the return node level.
